(19) United States
(12) Patent Application Publication
(10) Pub. No.: US 2014/0173451 A1
(43) Pub. Date: Jun. 19, 2014

(54) CREATING TASKS BASED ON NEWSFEED USER ENTRIES

(71) Applicant: MICROSOFT CORPORATION, Redmond, WA (US)

(72) Inventors: Eilene Hao Klaka, Redmond, WA (US); Eric Zenz, Seattle, WA (US); Biatrice Ambrosa, Redmond, WA (US); Amy Glaves, Marysville, WA (US)

(73) Assignee: Microsoft Corporation, Redmond, WA (US)

(21) Appl. No.: 13/714,640

(22) Filed: Dec. 14, 2012

(51) Int. Cl. G06F 3/0484

(52) U.S. Cl. CPC G06F 3/0484
USPC 715/744

(57) ABSTRACT

Systems and methods for creating and presenting task objects from newsfeed user entries are provided. A system may include a social networking provider, a task engine, and a client device. A method may include delivering, to a client device, a newsfeed user interface with a newsfeed having a plurality of entries; receiving, from the client device, a request to create a task based on an entry from the plurality of entries; connecting with a task engine, the task engine configured to create task objects; transmitting entry information associated with the entry to the task engine; and receiving, from the task engine, a confirmation indicating that a first task object was created based on the entry information.

### BACKGROUND

Social networking services often provide users with the ability to interact with a plurality of other users associated with the social networking service. Through such services, users are able to share entries with other users, such as ideas, instant message, links, photos, comments, opinions, blog posts, and other information. Often times, a user of a social networking service may view an entry that interests the user. In such scenarios, the user may desire to later retrieve and view the entry, follow-up on ideas or requests shared in the entry, ponder issues introduced in the entry, connect the entry to projects associated with the user, or the like.

It is with respect to these and other considerations that the disclosure made herein is presented.

### SUMMARY

Concepts and technologies are described herein for exporting data for task creation and presenting tasks. In accordance with the concepts and technologies disclosed herein, a system can include a newsfeed engine that communicates with a task engine.

Embodiments are provided for a computer-implemented method for creating tasks. In some embodiments, the method includes: delivering, to a client device, a newsfeed user interface with a newsfeed having a plurality of entries; receiving, from the client device, a request to create a task based on an entry from the plurality of entries; connecting with a task engine, the task engine configured to create task objects; transmitting entry information associated with the entry to the task engine; and receiving, from the task engine, a confirmation indicating that a first task object was created based on the entry information.

Further embodiments are provided for a computer-implemented method for presenting tasks. In some embodiments, the method includes: receiving user entry information from a social networking provider, the social networking provider configured to present a newsfeed user interface on a client device, the newsfeed user interface including one or more user entries; creating a task object based on the user entry information; sending a confirmation to the social networking provider, the confirmation indicating that the task object was created; storing the task object in a cache; accessing the task object from the cache; rendering the task object in a tasks user interface; and presenting the tasks user interface.

Further embodiments are provided for a system. The system may include a social networking provider, the social networking provider configured to: deliver a newsfeed user interface to a client device, the newsfeed user interface including one or more entries; receive a request to create a task based on a first entry from the one or more entries; and transmit entry information based on the first entry. The system may further include a task engine configured to receive the entry information from a social networking provider, the entry information based on the first entry of the one or more entries; create a first task object based on the user entry information; send a confirmation to the social networking provider, the confirmation indicating that the first task object was created; store the first task object in the cache; access the first task object from the cache; render the first task object in the tasks user interface; and deliver the tasks user interface to the client device. The client device may be configured to enable a user to view and interact with the newsfeed user interface and the tasks user interface.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an illustrative operating environment for the various embodiments disclosed herein.

FIG. 2 is a computer architecture diagram showing an illustrative computer hardware and software architecture for a computing system capable of implementing aspects of the embodiments presented herein.

FIG. 3 is a system diagram illustrating exemplary communications between various modules of the system for the various embodiments disclosed herein.

FIG. 4 is a flow diagram showing aspects of a method for creating tasks based on user entries, according to an illustrative embodiment.

FIG. 5 is a flow diagram showing aspects of a method for creating tasks based on user entries, according to an illustrative embodiment.

FIG. 6 is a flow diagram showing aspects of a method for creating tasks based on user entries, according to an illustrative embodiment.

FIG. 7 is a line drawing illustrating an exemplary newsfeed user interface, according to an illustrative embodiment;

FIG. 8 is a line drawing illustrating an exemplary newsfeed user interface, according to an illustrative embodiment;

FIG. 9 is a line drawing illustrating an exemplary tasks user interface, according to an illustrative embodiment.

### DETAILED DESCRIPTION

The following detailed description is directed to concepts and technologies for creating and presenting task objects from newsfeed user entries. In accordance with the concepts and technologies disclosed herein, a system can include a newsfeed engine that communicates with a task engine. The newsfeed engine hosts a newsfeed including one or more user entries in a newsfeed user interface. In some embodiments, a user of the newsfeed engine selects an entry for task creation. The newsfeed engine may send entry information to the task engine to create a task object based on the entry information. The task engine may further store the task in a cache or other data storage device associated with the task engine and/or the newsfeed engine. In some embodiments, the task engine displays the task in a task list presented on a tasks user interface. The newsfeed engine may indicate that a task was created in the newsfeed user interface, and further provide a link to the tasks user interface.

In some embodiments, the newsfeed engine is configured to generate and present a newsfeed user interface providing users with an option to create a task from a selected user entry. The newsfeed engine may update the newsfeed user interface to indicate to the user that a task was created. In addition, the newsfeed engine may be configured to synchronize with the task engine. For example, the newsfeed user interface may present one or more other attributes about the created task to the user. Modifications made to the created task in the task engine may be communicated to the newsfeed engine, and further indicated in the newsfeed user interface.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for creating and presenting tasks from user entries will be presented.

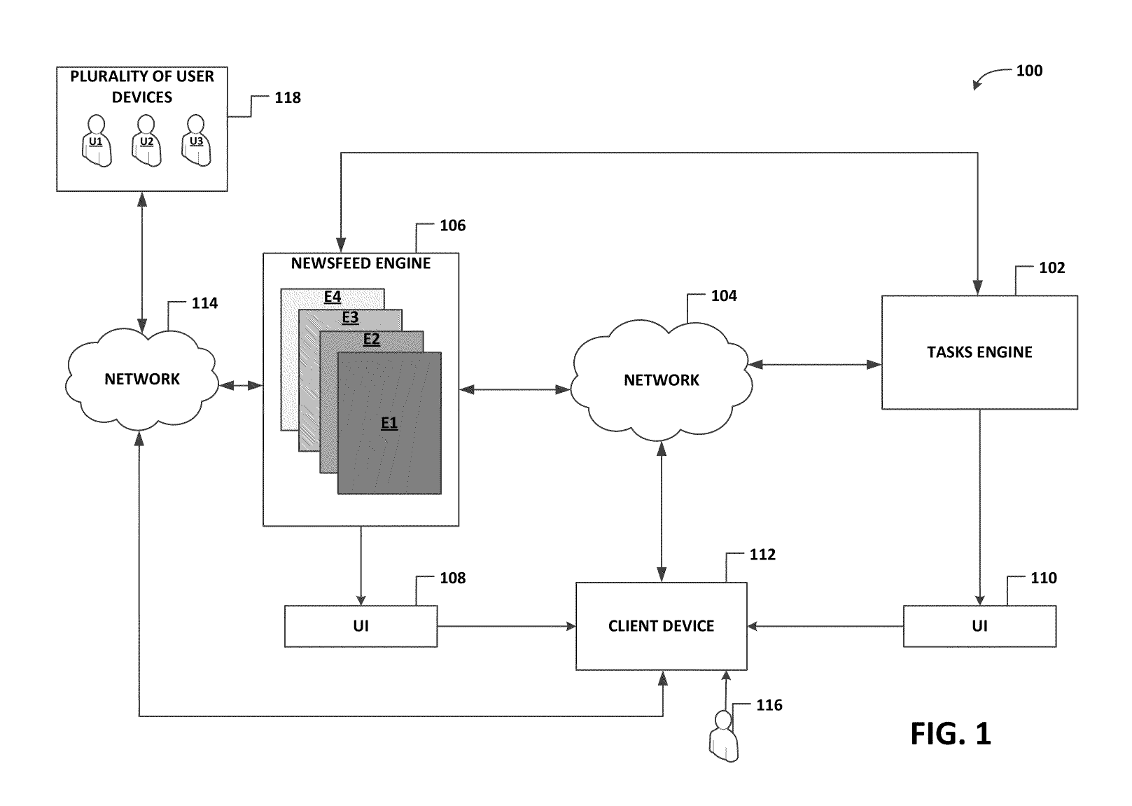

Referring now to FIG. 1, aspects of one operating environment 100 for the various embodiments presented herein will be described. The operating environment 100 shown in FIG. 1 includes a task engine 102, a network 104, a newsfeed engine 106, a newsfeed user interface 108, a tasks user interface 110, a client device 112, a network 114, and a plurality of users 118. The newsfeed engine 106 includes one or more user entries E1-E4. The client device is utilized by a user 116. The plurality of users 118 includes users, such as, for example, users U1-U3.

The task engine 102 operates as part of or in communication with the network 104. In general, the task engine 102 collects and aggregates information and creates task objects for presentation to a user in the tasks user interface 110 based on the information. The task engine 102 includes an operating system, such as a computer program, for controlling the operation of the task engine 102. In some embodiments, the task engine 102 includes executable programs configured to execute on top of the operating system to provide functionality for creating, aggregating, and presenting task objects. Detailed information on the functionality of the task engine 102 is explained in the co-pending patent application entitled, “Aggregating and Presenting Tasks”, application Ser. No. 13/295,113, filed Nov. 14, 2011, by Microsoft Corporation, et al., commonly assigned with the present application, which is incorporated by reference herein in its entirety.

The newsfeed engine 106 communicates with the task engine 102 via the network 104. In general, the newsfeed engine 106 is external to the task engine 102 and hosts a plurality of user entries E1-E4 which are displayed on one or more user interfaces, such as, for example, the newsfeed interface 108. The user entries E1-E4 are posted via the newsfeed engine 106 by the plurality of users 118, such as, for example, users U1-U3. In some embodiments, the plurality of users 118 communicates with the newsfeed engine 106 via the network 114. However, it is understood that in other embodiments, the plurality of users 118 communicates with the newsfeed engine 106 via the network 104.

In some embodiments, the newsfeed engine 106 is a social networking provider which provides social networking services to a plurality of users, such as the plurality of user 116. A social networking service can include various social networking services including, but not limited to, services for sharing or posting status updates, instant messages, links, photos, videos, and/or other entries; services for commenting or displaying interest in articles, products, blogs, or other resources; and/or other services. For purposes of brevity, all such user inputs will be referred to herein as user entries, such as, for example, the user entries E1-E4. In some embodiments, social networking services are provided by or include the FACEBOOK social networking service, the LINKEDIN professional networking service, the MYSPACE social networking service, the FOURSQUARE geographic networking service, the YAMMER office colleague networking service, and the like.

In other embodiments, the newsfeed engine 106 may be an indirect social networking service which primarily provides other services and may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash.

In some embodiments, the newsfeed engine 106 includes commenting, blogging, and/or microblogging services. For purposes of brevity, comments, requests, blog posts, and microblog posts, and the like will be included in the definition of user entries, and may be of the user entries E1-E4. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services are not mentioned herein for the sake of brevity. As such, the above embodiments are illustrative, and should not be construed as being limited in any way.

The network 104 communicates data between one or more computing devices, such as between the task engine 102, the newsfeed engine 106, and the client device 112. Similarly, the network 114 communicates data between one or more computing devices, such as between the newsfeed engine 106, the client device 112, and a plurality of user devices 116. Examples of the networks 104, 114 include a local area network and a wide area network, such as the Internet.

In some embodiments, the networks 104, 114 include a wireless communication system, a wired communication system, or a combination of wireless and wired communication systems. A wired communication system can transmit data using electrical or optical signals in various possible embodiments. Wireless communication systems typically transmit signals via electromagnetic waves, such as in the form of radio frequency (RF) signals. A wireless communication system typically includes a RF transmitter for transmitting radio frequency signals, and an RF receiver for receiving radio frequency signals. Examples of wireless communication systems include Wi-Fi communication devices (such as utilizing wireless routers or wireless access points), cellular communication devices (such as utilizing one or more cellular base stations), and other wireless communication devices.

The task engine 102 and the newsfeed engine 106 are configured to generate and present user interfaces 108, 110 on a client device 112. In some embodiments, the client device 112 can include software applications, other systems, and/or other entities. In the illustrated embodiment, the client device 112 operates in communication with the task engine 102, the network 104, and the newsfeed engine 106. This embodiment is illustrative and is provided as simply a description of the concepts and technologies disclosed herein. In some embodiments, for example, the client device 112 may be a computer executing a member of the MICROSOFT EXCHANGE family of products from Microsoft Corporation in Redmond, Wash. (an “EXCHANGE server”), such as, for example, Outlook Web Access. In some embodiments, a user, such as the user 116, may utilize the client device 112 to interact with the user interfaces 108, 110. The term “user” as used herein should be understood as referring to a broad range of systems, users, persons, devices, components, and the like, and the illustrated embodiment should not be construed as being limiting in any way.

In general, a user, such as the user 116, utilizes the client device 112 to view and interact with the user interfaces 108, 110. For example, the user 116 views the newsfeed user interface 108 to interact with one or more social networking providers, such as, for instance, the newsfeed engine 106. The user 116 may utilize the newsfeed user interface 108 to view one or more user entries, such as, user entries E1-E4. In some embodiments, the user entries E1-E4 include a task creation option which the user selects to create a task object for later follow-up. For example, the newsfeed user interface 108 may display a user entry posted by a user in the plurality of users 118, such as, user U1. The user entry may, for example, indicate that the user U1 is having a party on Dec. 1, 2012. The user 116 may select the user entry and click on an option on the user entry to create a task object. Thereafter, in some embodiments, the newsfeed engine 106 communicates the information associated with the user entry to the task engine 102, which creates a task object based on the user entry information. In some embodiments, the task engine 102 displays the created task object to the user in the tasks user interface 110 so that the user 116 may later view and follow-up on the information in the user entry. In this example, the user 116 may later view the created task on the tasks user interface 110 and recall that the user U1 is having a party on Dec. 1, 2012.

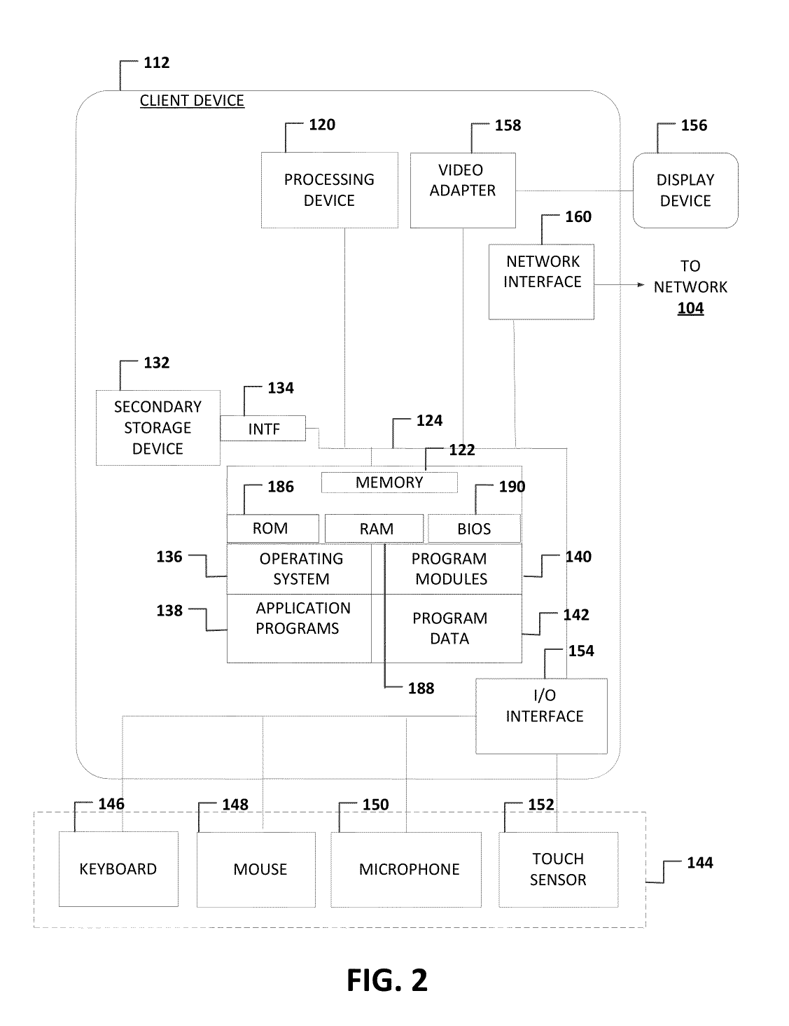

FIG. 2 illustrates an exemplary architecture of a computing device that can be used to implement aspects of the present disclosure, including, for example, the task engine 102, the newsfeed engine 106, and the client device 112, and will be referred to herein as the client device 112, for brevity. One or more computing devices, such as the type illustrated in FIG. 2, are used to execute the operating system, application programs, and software modules (including the software engines) described herein.

The client device 112 includes, in some embodiments, at least one processing device 120, such as a central processing unit (CPU). A variety of processing devices are available from a variety of manufacturers, for example, Intel or Advanced Micro Devices. In this example, the client device 112 also includes a system memory 122, and a system bus 124 that couples various system components including the system memory 122 to the processing device 120. The system bus 124 is one of any number of types of bus structures including a memory bus, or memory controller; a peripheral bus; and a local bus using any of a variety of bus architectures.

Examples of computing devices suitable for the client device 112 include a desktop computer, a laptop computer, a tablet computer, a mobile phone device such as a smart phone, or other devices configured to process digital instructions.

The system memory 122 includes read only memory 186 and random access memory 188. A basic input/output system 190 containing the basic routines that act to transfer information within client device 112, such as during start up, is typically stored in the read only memory 186.

The client device 112 also includes a secondary storage device 132 in some embodiments, such as a hard disk drive, for storing digital data. The secondary storage device 132 is connected to the system bus 124 by a secondary storage interface 134 and is removable. The secondary storage devices and their associated computer readable media provide nonvolatile storage of computer readable instructions (including application programs and program modules), data structures, and other data for the client device 112.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 132 or memory 122, including an operating system 136, one or more application programs 138, other program modules 140, and program data 142.

In some embodiments, client device 112 includes input devices to enable the user to provide inputs to the client device 112. Examples of input devices 144 include a keyboard 146, pointer input device 148, microphone 150, and touch sensitive display 152. Other embodiments include other input devices 144. The input devices are often connected to the processing device 120 through an input/output interface 154 that is coupled to the system bus 124. These input devices 144 can be connected by any number of input/output interfaces, such as a parallel port, serial port, game port, or a universal serial bus. Wireless communication between input devices and interface 154 is possible as well, and includes infrared, BLUETOOTH® wireless technology, 802.11a/b/g/n, cellular or other radio frequency communication systems in some possible embodiments.

In this example embodiment, a touch sensitive display device 156 is also connected to the system bus 124 via an interface, such as a video adapter 158. The touch sensitive display device 156 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

When used in a local area networking environment or a wide area networking environment (such as the Internet), the client device 112 is typically connected to the network through a network interface, such as a wireless network interface 160. Other possible embodiments use other communication devices. For example, some embodiments of the client device 112 include an Ethernet network interface, or a modem for communicating across the network.

The client device 112 typically includes at least some form of computer-readable media. Computer readable media includes any available media that can be accessed by the client device 112. By way of example, computer-readable media include computer readable storage media and computer readable communication media, which is discussed below in more detail.

Various embodiments of operating system 100 and/or client device 112 may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 122, removable storage 132, and non-removable storage 186, 188 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the client device 112. Any such computer storage media may be part of the client device 112. The client device 112 may also have input device(s) 144, as stated above, such as a keyboard, a mouse, a pen, a sound input device (e.g., a microphone), a touch input device, etc. Output device(s) such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

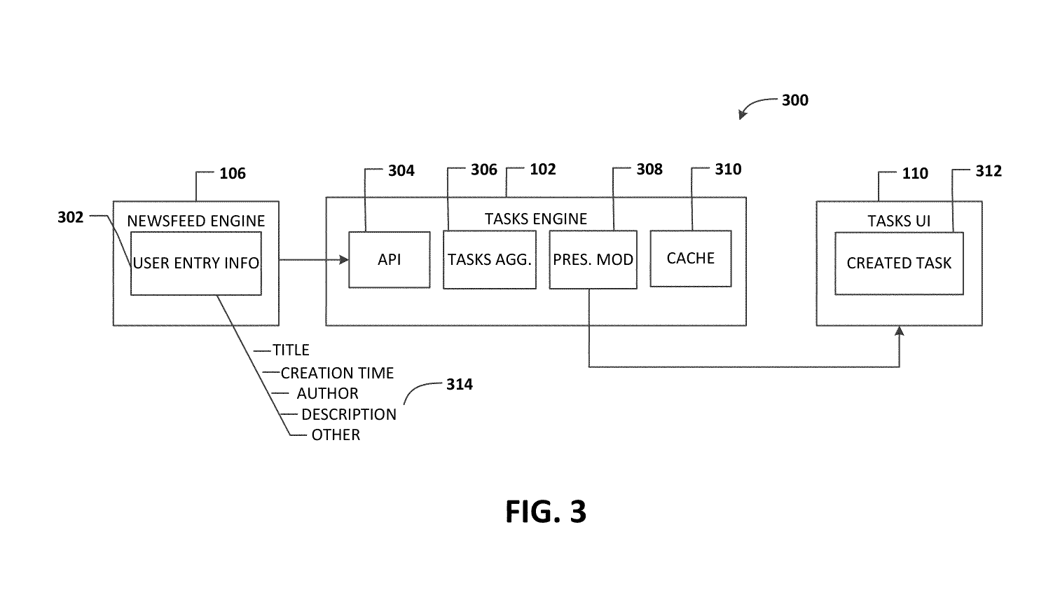

Now referring to FIG. 3, a schematic diagram of aspects of a system 300 is shown. The system 300 includes the newsfeed engine 106, user entry information 302, the task engine 102, and the tasks user interface 110. The task engine 102 includes an application programming interface (“API”) 304, a task aggregator 306, and a presentation module 308. The user entry information 302 may be sorted into one or more categories 314. The tasks user interface 110 displays a created task 312.

The newsfeed engine 106 may communicate with the task engine 102 via the API 304. In some embodiments, the task engine 102 exposes API 304 so that the newsfeed engine 106 can submit user entry information, such as the user entry information 302, to the task engine 102. Prior to submitting the user entry information 302, the task engine 102 may authenticate the newsfeed engine 106.

In some embodiments, the API 304 accepts information related to a user entry, such as the user entry information 302. In alternate embodiments, the API 304 may accept various parameters of the user entry information 302, such that the newsfeed engine 106 must sort a user entry into the one or more categories 314 of user entry information. For example, the API 304 may request parameters (e.g., categories) including, but not limited to, a creation time and date, a due date, a location associated with the user entry, a title, an author of the user entry, and other information associated with the user entry, such as, a description of the task object. In some embodiments, the description of the task object includes a message body of the entry or any other text associated with the entry. The location of the user entry can correspond to a URL or resource location for the newsfeed engine 106 from which the user entry is obtained, for example, or another location associated with the user entry. The other information may include a flag indicator that indicates a priority level, a team or other user associated with the user entry, a project with which the user entry is associated, a completion state associated with the user entry, and/or other information. The API 304 may request any desired information used by the task aggregator 306 to create a task object, organize and/or catalogue the user entry information and/or the presentation module 308 to present the created task 312 in the tasks user interface 110. In yet further embodiments, the API 304 may not request any parameters, and simply accepts the user entry as it exists in the newsfeed engine 106.

The user entry information 302 communicated from the newsfeed engine 106 is collected by the task aggregator 306. The task aggregator 306 may be configured to recognize received data as user entry information, to organize and/or catalogue the user entry information 302, to create a task object from the user entry information 302, and/or to store the user entry information 302 and/or a created task in a data storage location, such as the cache 310. In other embodiments, the task aggregator 306 may accept the user entry information 302 and proceed to store the user entry information 302 in a data storage location without organizing and/or cataloguing the data.

In some embodiments, the API 304 directly creates a task object from received user entry information. For example, the API 304 may be configured to recognize received data as user entry information, to organize and/or catalogue the user entry information 302, to create a task object from the user entry information 302, and/or to store the user entry information 302 and/or a created task in a data storage location, such as the cache 310.

In some embodiments, the task aggregator 306 is configured to store the user entry information 302 in task data in the cache 310. The cache 310 can be hosted by or can be in communication with the task engine 102 and/or the newsfeed engine 106. Although not illustrated in FIG. 3, the cache 310 may be directly or indirectly accessible to the newsfeed engine 106. In some embodiments, the functionality of the cache 310 is provided by a memory device, a hard drive, or other storage device of the device providing the functionality of the task engine 102. In other embodiments, the functionality of the cache 310 is provided by one or more data storage devices in communication with the task engine 102 such as, for example, one or more databases, server computers, mass storage devices, memory devices, combinations thereof, and the like. Thus, it is understood, that in some embodiments, the cache 310 may be external to the task engine 102, and may be accessed via a network, such as the network 104.

As stated above, in some embodiments, the task engine 102 and the newsfeed engine 106 have access to the cache 310 where the user entry information 302 is stored. In such embodiments, modifications to the user entry information 302 by a user, via the tasks user interface 110, may be accessed by both the task engine 102 and the newsfeed engine 106. Thus, modifications, updates, deletions, and any other user alteration of the user entry information 302 may be reflected in both the newsfeed user interface 108 and the tasks user interface 110. However, it is understood that in some embodiments, such user alterations of the user entry information 302 may be reflected in only one of the user interfaces 108, 110, both, or neither.

In yet further embodiments, the newsfeed engine 106 may independently store the user entry information 302 in a newsfeed engine data store (not shown). In some embodiments, the task aggregator 306 is configured to communicate changes made to the user entry information 302 to the newsfeed engine 106. The newsfeed engine 106 may utilize such communications to update the user entry information 302 and the associated user entry stored by the newsfeed engine 106. Such changes may be reflected in the newsfeed user interface 108.In yet further embodiments, the task engine 102 stores user entry information and data representative of created task objects, and/or the created objects in the cache 310 and the newsfeed engine 106 stores user entry information and data representative of created task objects and/or created task objects in an independent newsfeed engine data store (not shown). The task engine 102 may be configured to synchronize the independent newsfeed engine data store with the cache 310. Thus, in some embodiments, upon creating, modifying, and/or deleting task objects in the cache 310, the task engine 102 may communicate with the newsfeed engine 106 via the API 304 and transmit synchronization data to the newsfeed engine 106 to synchronize the independent newsfeed engine data store with the cache 310.

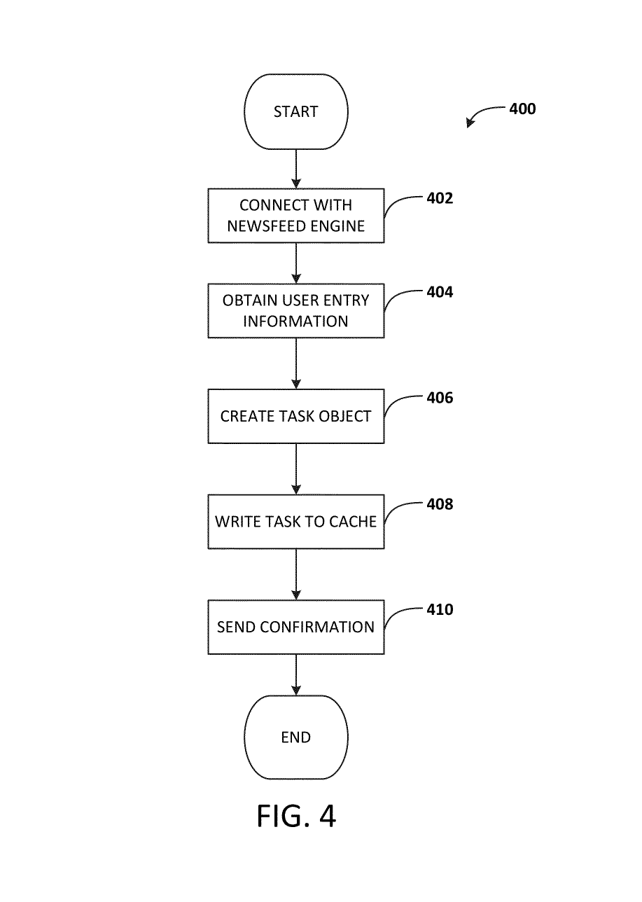

The presentation module 308 is configured to generate and present the tasks user interface 110 to one or more users. As mentioned above, the users can include software users, other software applications, other systems, and/or other entities. The presentation module 308 can provide any number of user interfaces to users for interaction with the created tasks, such as created task 312. Users can utilize the tasks user interface 110 to modify the created tasks. The presentation module 308 may communicate with the task aggregator 306 to indicate changes made to the tasks. In some embodiments, the presentation module 308 may be further configured to communicate changes to the created tasks to the newsfeed module 106, thereby allowing the newsfeed module 106 to indicate any such changes in the newsfeed user interface 108. In some embodiments, the presentation module 308 utilizes the cache to gather information to be presented in the tasks user interface 110. However, in alternate embodiments, the task engine 102 may directly send information, such as a created task, to the presentation module 308, for presentation on the tasks user interface 110. Turning now to FIG. 4, aspects of a method 400 for creating tasks from newsfeed entries will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the task engine 102 via execution of the API 304, the task aggregator 306, and/or the presentation module 308. It should be understood that these embodiments are illustrative, and should not be viewed as being limiting in any way. In particular, devices other than the task engine 102 can provide the functionality described herein by execution of any applications or modules including, but not limited to, the API 304, the task aggregator 306, and/or the presentation module 308.

The method 400 begins at operation 402, wherein the task engine 102 connects with the newsfeed engine 106. As stated above, communications between the task engine 102 and the newsfeed engine 106 can be initiate can be initiated via the API 304. For example, the newsfeed engine 106 may request connection with the task engine 102 based on user selection of a task creation option in the newsfeed user interface 108. In some embodiments, the newsfeed engine 106 may access the task engine 102 via the API 304. For example, the task engine 102 can expose the API 304 to the newsfeed engine 106 to allow the newsfeed engine 106 to directly communicate with the task engine 102. In yet further embodiments, the task engine 102 may request authentication with the newsfeed engine 106 and/or identification of a user or system for which a task is to be created.

From operation 402, the method 400 proceeds to operation 404, wherein the task engine 102 obtains user entry information from the newsfeed engine 106. As explained, the user entry information can be submitted to the task engine 102 by the newsfeed engine 106 in response to a request from a user of the newsfeed engine 106 by selecting an option associated with a user entry. In some embodiments, the newsfeed engine 106 thereafter transmits information associated with the user entry, such as the user entry information 302, to the task engine 102. In yet further embodiments, the API 304 may request that the user entry information 302 is submitted with one or more parameters or categories of data, as explained above with reference to FIG. 3. In such examples, the newsfeed engine 106 may extract such data from the user entry and transmit the extracted data to the API 304. For example, in some embodiments, the API 304 may request a title parameter for the task. In some embodiments, the newsfeed engine 304 may utilize the body of the user entry as the title parameter for the task. It is understood, however, that in other embodiments, the API 304 may request two or more parameters or no parameters.

From operation 404, the method 400 proceeds to operation 406, wherein the task engine 102 creates a task object from the user entry information. In some embodiments, the task engine 102 submits the user entry information received from the newsfeed engine 106 to the task aggregator 306. The task aggregator 306 may utilize the user entry information and any parameters of information to create a task object 312 based on the functionality of the task engine 102.

From operation 406, the method 400 proceeds to operation 408, wherein the task engine 102 writes the created task 312 to the cache 310. It is understood, however that in some embodiments, the task engine 102 does not write the create task 312 to the cache 310, and instead, proceeds to send the created task 312 to the presentation module 308.

From operation 408, the method 400 proceeds to operation 410, wherein the task engine 102 communicates a confirmation of task creation to the newsfeed engine 106. In some embodiments, after receiving the confirmation from the task engine 102, the newsfeed engine 106 displays a notification to the user on the newsfeed user interface 108 that a task has been created based on the user-selected user entry. In yet further embodiments, the newsfeed engine 106 may alternatively or additionally redirect the user to the tasks user interface 110 and/or provide a link to the tasks user interface 110 whereby the user may view and interact with the created task 312 in a task list.

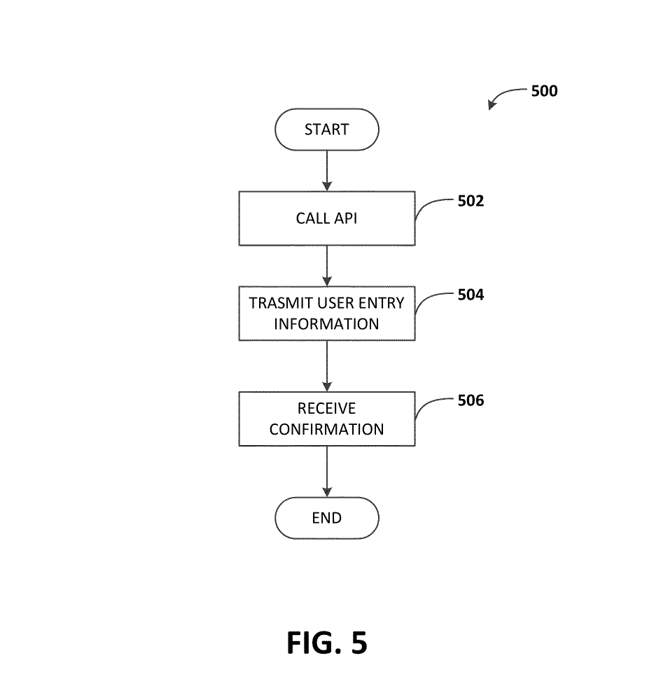

Turning now to FIG. 5, aspects of a method 500 for communicating user entry information for task creation will be described in detail. The method 500 begins at operation 502, wherein the newsfeed engine 106 calls the API 304 in an attempt to connect with the task engine 102. As stated above, the task engine 102 can publically expose the API 304 to the newsfeed engine 106 to allow the newsfeed engine 106 to directly communicate with the task engine 102. In some embodiments, the API 304 may authenticate the newsfeed engine 106 prior to enabling communication between the newsfeed engine 106 and the task engine 102.

From operation 502, the method 500 proceeds to operation 504, wherein the newsfeed engine 106 transmits user entry information to the task engine 102 via the API 304. The newsfeed engine 106 may extract information from a user entry, such as, for example, the user entry E1, and transmit the extracted data to the task engine 102. For instance, the API 304 may request that the newsfeed engine 106 send a title for the task. In some embodiments, the newsfeed engine 106 may send the text of the user entry E1 as the title of the task. In other embodiments, the API 304 request further parameters, as described above with reference to FIG. 3. The newsfeed engine 106 may transmit as many parameters as are necessary to successfully complete the task creation operation.

From operation 504, the method 500 proceeds to operation 506, wherein the newsfeed engine receives a confirmation from the task engine 102 that a task object has been created based on the user entry information transmitted in the operation 504. The confirmation may be sent via a network, such as the network 104, from the task engine 102 to the newsfeed engine 106. In some embodiments, after receiving the confirmation from the task engine 102, the newsfeed engine 106 displays a notification to the user on the newsfeed user interface 108 that a task has been created based on the user-selected user entry. In yet further embodiments, the newsfeed engine 106 may alternatively or additionally redirect the user to the tasks user interface 110 and/or provide a link to the tasks user interface 110 whereby the user may view and interact with the created task 312 in a task list. For example, the notification displayed on the newsfeed user interface 108 may include a link that, when selected by a user, redirects the user to the tasks user interface 110.

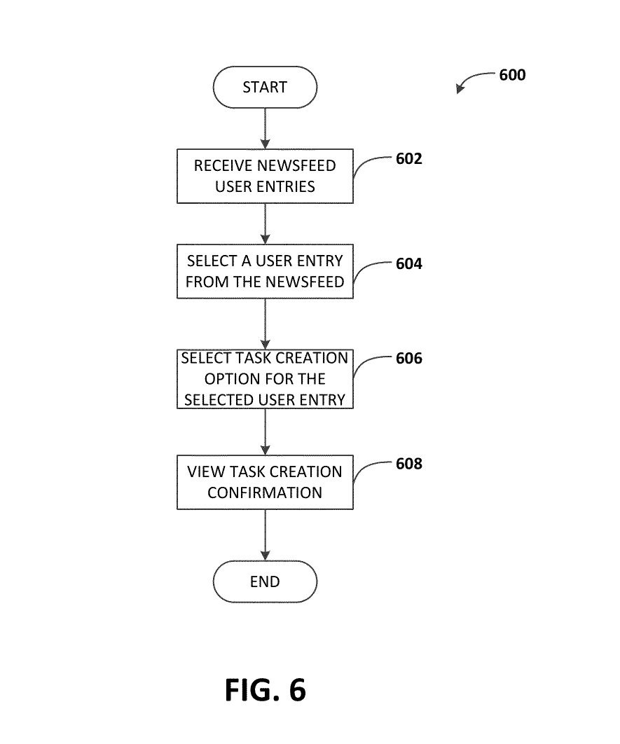

Turning now to FIG. 6, aspects of a method 600 for user selection of a task creation option will be described in detail. The method 600 begins at operation 602, wherein a user, such as the user 116, receives newsfeed entries on a newsfeed user interface, such as the newsfeed user interface 108. The newsfeed entries may be any entries inputted by users or the newsfeed engine 106, such as, for example, the plurality of users 118. In some embodiments, the user entries may be directed at the user 116 and appear on a profile belonging to the user 116. In other embodiments, the user entries may not be directed at the user 116, but instead, but appear on a public news stream of entries visible to the user 116.

From operation 602, the method 600 proceeds to operation 604, wherein the user 116 selects a specific user entry from the newsfeed entries. In some embodiments, the user 116 selects a user entry on the newsfeed user interface 108 by utilizing an input device, such as, for example, the mouse 148. In other embodiments, the user 116 may utilize any other input device, including, for example, the keyboard 146, the microphone 150, the touch sensor 152, or the like, to select the user entry.

From operation 604, the method 600 proceeds to operation 606, wherein the user 116 selects a task creation option for the selected user entry. The user 116 may use the input device, for example, to click on the selected user entry to view a menu which includes an option to create a task based on the user entry. In some embodiments, the menu may include an option to “Follow-up” on the user entry. The user 116 may select the “Follow-up” option to create a task based on the user entry. In other embodiments, the task creation option may utilize any other language indicating to the user 116 that selection of the option results in creation of a task based on the user entry.

From operation 606, the method 600 proceeds to operation 608, wherein the user 116 views a task creation notification on the newsfeed user interface 108. After selection of the task creation option for a selected user entry, the newsfeed engine 106 may communicate user entry information to the task engine 102 for task creation based on the user entry information. In some embodiments, thereafter, the task engine 102 may return a confirmation of task creation to the newsfeed engine 106. The newsfeed engine 106 may then modify the newsfeed user interface 108 to present a notification to the user 116 that task creation was successful. In some embodiments, the notification may include a link to the tasks user interface 110 wherein the user 116 may view the created task in his/her task list.

In some embodiments, the newsfeed user interface 108 may not present a confirmation, but instead, redirect the user 116 to the tasks user interface 110 wherein the user 116 may view the created task. In other embodiments, if the task creation function is not successful, the newsfeed user interface 108 may display a notification indicating the failure. However, in yet further embodiments, the newsfeed user interface 108 may not display any notification if there is a failure in the task creation function.

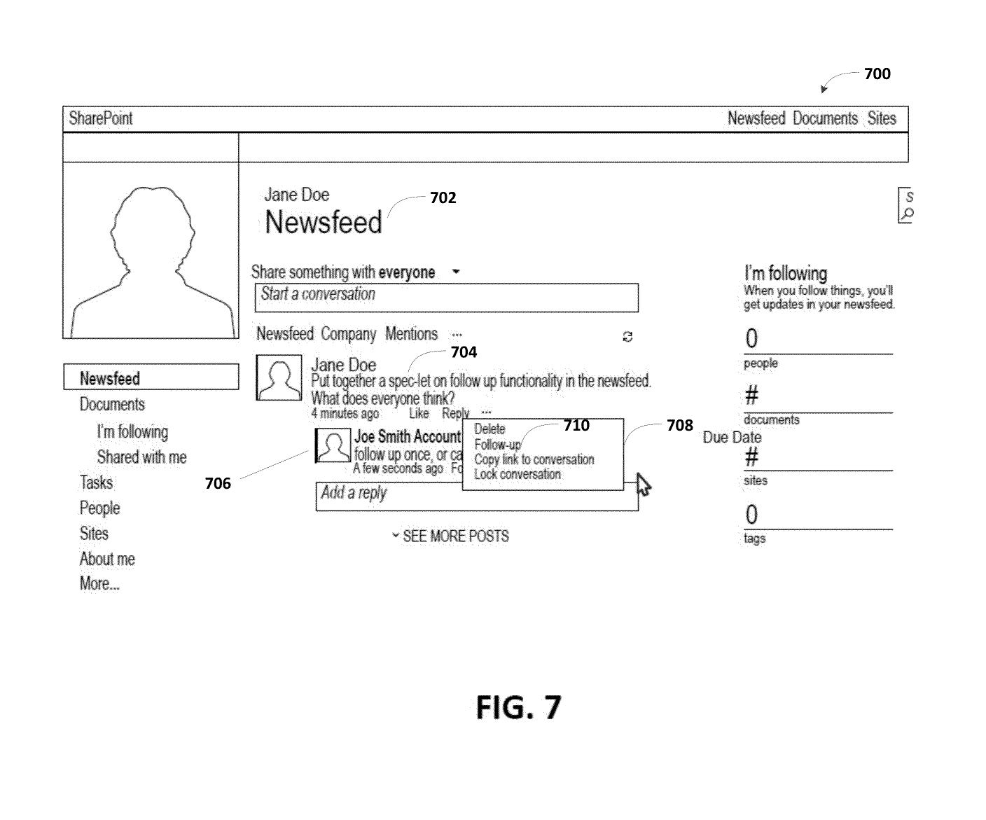

Now referring to FIG. 7, an example newsfeed user interface 700 is illustrated. The newsfeed user interface 700 includes a newsfeed 702, a first user entry 704, a second user entry 706, a menu 708, and a follow-up option 710. The newsfeed user interface 700 is one example of a user interface displayed to the user 116 on the client device 112 by a social networking provider, such as, for example, the newsfeed engine 106.

In some embodiments, the newsfeed 702 may be part of a user profile associated with the user 116 and displayed by the newsfeed engine 106. In such examples, the user profile may include one or more user entries, such as the first user entry 704 and the second user entry 706 which are either posted directly by the user 116 or by another user, but intended for viewing by the user 116. In other embodiments, the newsfeed 702 may be part of a news stream of one or more user entries displayed by the newsfeed engine 106. In such examples, the one or more user entries may not be directly intended for the user 116, but are nonetheless visible by the user 116. In some embodiments, only user entries directed at the user 116 may be selected for task creation by the user 116. However, in other embodiments, any user entry, whether intended for the user 116 or not, may be selected by the user 116 for task creation.

The user 116, in the example, Jane Doe, posted the first user entry 704. In response, a second user, Joe Smith, posted a reply post, the second user entry 706. If Jane Doe is interested in the subject-matter of the second user entry 706, she may decide to create a task based on the second user entry 706. In some embodiments, to do this, Jane Doe utilizes an input device, such as a mouse, to select the second user entry 706 to view the menu 708. Methods of selection may vary, and include, but are not limited to, left click, right click, touch, double click, or any other methods of selection. In further embodiments, the user 116 may view the menu 708 by utilizing an input device to hover above the second user entry 706, or the like.

In some embodiments, such as the present example, the menu 708 includes a task creation option associated with the second user entry 706. In the example, Jane Doe selects the follow-up option 710 to create a task based on the second user entry 706, which may be later viewed on a tasks user interface, such as the tasks user interface 110. In other embodiments, the follow-up option 710 may include differing language, but when selected by the user 116, results in the same operations as discussed herein.

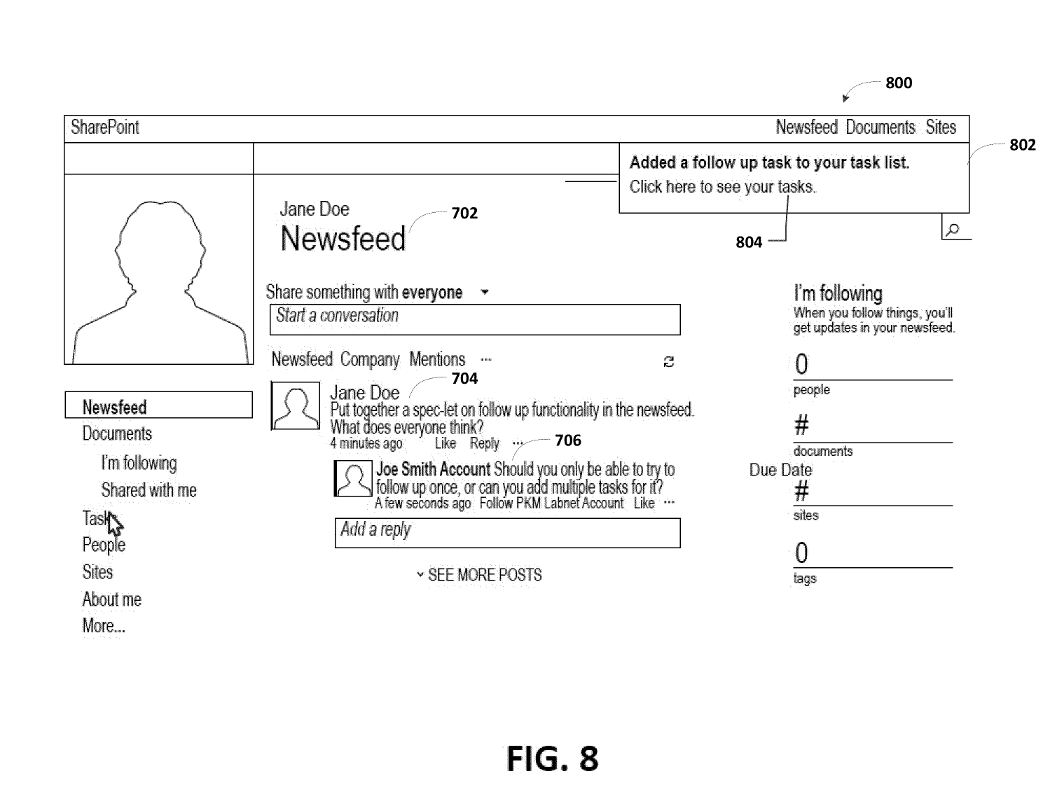

Now referring to FIG. 8, an example newsfeed user interface 800 is illustrated. In general, the newsfeed user interface 800 is one example of a newsfeed user interface that is displayed to the user 116 after selection of a task creation option, such as, for example, the follow-up option 710.

In some embodiments, after selection of the follow-up option 710, a notification, such as the notification 802 is presented to the user 116. Though the notification 802 may differ in language in differing embodiments, the notification 802 is displayed to inform the user 116 that a task has been created based on the selected user entry. Thus, for example, if Jane Doe selected the follow-up option 710 to create a task based on the second user entry 706 and the task creation was successful, the notification 802 may be presented as shown to indicate that a task was created based on the second user entry 706.

The notification 802 may include a link 804 which when selected by the user 116, redirects the user 116 to the tasks user interface 110. In some embodiments, the link 804 redirects the user 116 to a tasks user interface to view a task list with all tasks associated with the user 116 and/or the newly created task based on the second user entry 706. In other embodiments, the link 804 redirects the user 116 to a log-in page wherein the user 116 may log-in with credentials associated with the task engine 102, whereby after logging-in, the user 116 may view a task list associated with the user 116 and/or the newly created task based on the second user entry 706. In yet further embodiments, the newsfeed user interface 800 does not display the notification 802, but instead, automatically redirects the user 116 to either the tasks user interface 110 and/or a log-in page associated with the task engine 102.

In some embodiments, in addition to or alternative to displaying the notification 802, the newsfeed user interface 800 may indicate that task creation was successful by including an indicator on the second user entry 706. For example, in some embodiments, beside the “Like” option on the second user entry 706, the newsfeed user interface 800 may include a link indicating that the second user entry 706 is now a task. The link may state, for example, “Task created” or “View task,” which when selected, redirects the user 116 in similar ways as the link 804. In alternate embodiments, the link on the second user entry 706 states, for example, “Delete Task”, “Do Not Follow-up”, and/or “Mark Task Complete”, or the like indicating that the second user entry 706 is currently a task and further action may be taken. In such embodiments, if selected by the user 116, the newsfeed engine 106 may connect with the task engine 102, in the same methods as described herein, and request deletion of the associated task or request that the associated task is marked as complete. In such embodiments, the task aggregator 308 may access the created task from the cache 310 and delete the task and/or mark the task as completed. Thereafter, the presentation module 308 may modify the tasks user interface 110 to delete the task from the user's task list or mark the task as completed in the user's task list. Similarly, if the user 116 deletes the created task in the tasks user interface 110, in some embodiments, this is communicated to the newsfeed engine 106. In response, the newsfeed engine 106 may modify the newsfeed user interface 800 to display a notification indicating that the task has been deleted and/or marked as complete. In other embodiments, the newsfeed engine 106 may alter the link on the second user entry 706 from “Delete Task” or “Do Not Follow-up” to “Create Task” or “Follow-up”, thus indicating, that an option to create a task based on the second user entry 706 is now available because a task no longer exists based on the second user entry 706. In yet further embodiments, the newsfeed engine 106 may alter the link on the second user entry 706 from “Mark Task Complete” to “Mark Task Incomplete” indicated that an option to mark the associated task as incomplete. It is understood that the embodiments listed above are only examples, and thus, the links may utilize alternate wording but accomplish a similar function.

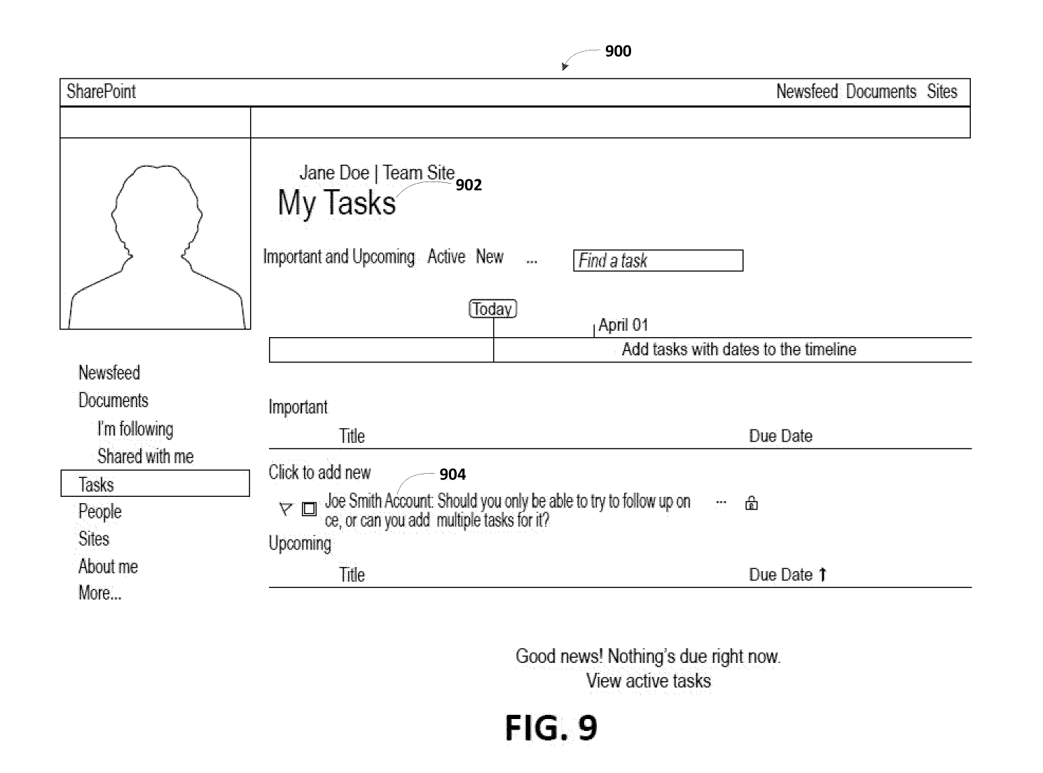

Referring now to FIG. 9, an exemplary tasks user interface 900 is shown. The tasks user interface 900 is one example of what the user 116 is redirected to upon selecting the link 804. The tasks user interface 900 includes a tasks list 902 that is specific to the user 116 and a created task 904 based on the second user entry 706.

As shown, in some embodiments, the created task 904 will include the body of the second user entry 706 as the title of the task. In other embodiments, the newsfeed engine 106 may provide the user 116 with a title option. By way of the tasks user interface 900, the user 116 may view a list of all created tasks, which may be from various tasks system, such as the newsfeed engine 106. In addition, the user 116 may modify the task, for example, update, revise, alter, and/or delete the task. In some embodiments, the user 116 may change various parameters of the post, including the title, due date, creation date, body, description, priority level, completion status, and the like. As stated above, alterations made to the create task 904 on the tasks user interface 900 may, in some embodiments, be reflected in a newsfeed user interface, such as the newsfeed user interface 800. In this way, in some embodiments, the newsfeed engine 106 synchronizes with the task engine 102. However, it is understood that in alternate embodiments, alterations to the created task 904 has no effect on the newsfeed user interface 800.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routines' operations may be modified in any manner, including by reordering operations and/or inserting or operations, without departing from the embodiments described herein.

Based on the foregoing, it should be appreciated that technologies for aggregating and presenting tasks have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

1. A computer-implemented method for creating tasks, the computer-implemented method comprising performing computer-implemented operations for:
delivering, to a client device, a newsfeed user interface with a newsfeed having a plurality of entries;
receiving, from the client device, a request to create a task based on an entry from the plurality of entries;
connecting with a task engine, the task engine configured to create task objects;
transmitting entry information associated with the entry to the task engine; and
receiving, from the task engine, a confirmation indicating that a first task object was created based on the entry information.

2. The method of claim 1, further comprising:
delivering, to the client device, a notification on the newsfeed user interface indicating that the first task object was created.

3. The method of claim 1, wherein the newsfeed user interface provides an option for a user to select an entry in the plurality of entries for task creation based on the entry.

4. The method of claim 3, wherein the option is presented on a menu to the user after the user selects the entry with an input device.

5. The method of claim 1, further comprising:
receiving, from the task engine, an indication that the first task object was modified; and
in response to receiving the indication, modifying the newsfeed user interface to indicate that the first task object was modified.

6. The method of claim 1, wherein connecting with the task engine comprises:
calling an application programming interface exposed by the task engine.

7. The method of claim 6, further comprising:
transmitting authenticating information to the application programming interface.

8. The method of claim 1, wherein the entry information comprises data indicating a title for the first task object.

9. The method of claim 8, wherein the data is the body of the first selected entry.

10. The method of claim 1, wherein the entry is a micro-blog post.

11. (canceled)

12. The method of claim 1 further comprising:
receiving, from the user, a request to delete or modify the first task object;
sending, to the tasks engine, data indicative of the request the first task object; and
indicating on the newsfeed user interface that the first task object has been updated based on the request.

13. A computer-implemented method for presenting tasks, the computer-implemented method comprising performing computer-implemented operations for:
receiving user entry information from a provider;
creating a task object based on the user entry information;
storing the task object in a cache;
accessing the task object from the cache;
rendering the task object in a tasks user interface; and
presenting the tasks user interface.

14. The method of claim 13, further comprising:
enabling the client device to modify the task object via the tasks user interface;
determining that there has been a modification of the task object;
storing the modified task object in the cache; and
sending data indicative of the modification to the provider.

15. The method of claim 13, wherein the provider has access to the cache.

16. The method of claim 13, wherein the user entry information comprises data indicating at least one of: a title, an author, a creation date, a completion status, and a description of the task object.

17. The method of claim 21 further comprising:
receiving, from the social networking provider, data indicative of a request to delete the task object;
deleting the task object from the cache; and
refreshing the tasks user interface so that the task object is removed from the tasks user interface.

18. The method of claim 21 further comprising:
receiving, from the social networking provider, data indicative of a request to mark the task object as completed;
retrieving the task object from the cache;
modifying a completion status of the task object; and
refreshing the tasks user interface to reflect the modification in the completion status of the task object.

19. A system comprising:
a social networking provider, the social networking provider configured to:
deliver a newsfeed user interface to a client device, the newsfeed user interface including one or more entries;
receive a request to create a task based on a first entry from the one or more entries; and
transmit entry information based on the first entry;
a task engine comprising:
a task aggregator configured to create task objects;
a cache configured to store task objects;
a presentation module configured to generate and display a tasks user interface,
the task engine configured to:
receive the entry information from a social networking provider, the entry information based on the first entry of the one or more entries;
create a first task object based on the user entry information;
send a confirmation to the social networking provider, the confirmation indicating that the first task object was created;
store the first task object in the cache;
access the first task object from the cache;
render the first task object in the tasks user interface; and
deliver the tasks user interface to the client device; and
the client device configured to enable a user to view and interact with the newsfeed user interface and the tasks user interface.

20. The system of claim 19 wherein the newsfeed user interface includes a link, which when selected, redirects the client device to the tasks user interface.

21. The method of claim 13, wherein the provider is a social networking provider, the social networking provider configured to present a newsfeed user interface on a client device, the newsfeed user interface including one or more user entries.
